(19) United States
(12) Patent Application Publication
(10) Pub. No.: US 2026/0358869 A1
(43) Pub. Date: Nov. 12, 2026

(54) COOLING SYSTEMS FOR COMPUTER SYSTEM COMPONENTS AND METHODS OF OPERATING THE SAME

(71) Applicant: Taiwan Semiconductor Manufacturing Company, Ltd., Hsinchu (TW)

(72) Inventors: Chung-Chiu WU, Taipei (TW); Wei-Sheng LIN, Hsinchu (TW)

(73) Assignee: Taiwan Semiconductor Manufacturing Company, Ltd., Hsinchu (TW)

(21) Appl. No.: 19/749,476

(22) Filed: Jul. 21, 2026

Related U.S. Application Data
(63) Continuation of application No. 18/795,820, filed on Aug. 6, 2024.

(51) Int. Cl. G06F 1/20

(52) U.S. Cl. CPC G06F 1/20; G06F 2200/201

(57) ABSTRACT

An embodiment two-phase cooling system includes an enclosure having a first volume and a second volume, a heat source located in the first volume, and a liquid coolant located in the first volume such that the liquid coolant is in contact with the heat source. A vapor partially filling the second volume is generated by the liquid coolant when heat generated by the heat source is absorbed by the liquid coolant. A condenser located in the second volume removes heat from the vapor, thereby condensing the vapor into condensed liquid coolant that returns to the first volume. A positioning device, located in the second volume and attached to the condenser, controls a position or orientation of the condenser within the second volume to increase a spatial overlap of the vapor with the condenser, thereby increasing an efficiency of the heat-transfer coupling between the vapor and the condenser.

### CROSS-REFERENCE TO RELATED APPLICATION

This application is a continuation of U.S. patent application Ser. No. 18/795,820, filed on Aug. 6, 2024, the entire disclosure of which is incorporated herein by reference.

### BACKGROUND

Cooling systems are used to maintain optimal temperatures in computer systems, especially for components such as central processing units (CPUs) and graphics processing units (GPUs) that generate considerable heat during operation. There are several types of cooling solutions, including air cooling, liquid cooling, and phase-change cooling. Each has its own advantages and is suited for different scenarios depending on factors including performance requirements, space constraints, and budget. Liquid cooling systems are increasingly being adopted in high-performance computing environments where conventional air cooling may fall short in dissipating the heat generated by components such as CPUs and GPUs.

One key advantage of liquid cooling lies in its efficiency at transferring heat away from heat sources. In contrast to air, liquid has a higher heat capacity, enabling it to absorb more heat before reaching critical temperatures. Additionally, liquid cooling solutions tend to operate more quietly than their air-cooled counterparts, as they rely on pumps rather than fans for heat dissipation. This reduced noise level can be particularly appealing in environments where noise is a concern. Despite advances in liquid cooling systems, challenges remain and there is an ongoing need for improvement in cooling systems for computer components and data systems.

### BRIEF DESCRIPTION OF THE DRAWINGS

Aspects of this disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a vertical cross-sectional view of a two-phase cooling system, according to an embodiment.

FIG. 1B is a top view of the two-phase cooling system of FIG. 1A illustrating one configuration of a condenser.

FIG. 1C is a top view of the two-phase cooling system of FIG. 1A illustrating a further configuration of a condenser, according to an embodiment.

FIG. 2A is a three-dimensional perspective view of a two-phase cooling system in a first configuration, according to various embodiments.

FIG. 2B is a three-dimensional perspective view of the two-phase cooling system of FIG. 2A in a second configuration, according to various embodiments.

FIG. 3A is a vertical cross-sectional view of a two-phase cooling system, according to various embodiments.

FIG. 3B is a three-dimensional perspective view of the two-phase cooling system of FIG. 3A in a first configuration, according to various embodiments.

FIG. 3C is a three-dimensional perspective view of the two-phase cooling system of FIG. 3A in a second configuration, according to various embodiments.

FIG. 4A is a vertical cross-sectional view of a two-phase cooling system, according to various embodiments.

FIG. 4B is a three-dimensional perspective view of the two-phase cooling system of FIG. 4A in a first configuration, according to various embodiments.

FIG. 4C is a three-dimensional perspective view of the two-phase cooling system of FIG. 4A in a second configuration, according to various embodiments.

FIG. 5A is a vertical cross-sectional view of a two-phase cooling system, according to various embodiments.

FIG. 5B is a three-dimensional perspective view of the two-phase cooling system of FIG. 5A in a first configuration, according to various embodiments.

FIG. 5C is a three-dimensional perspective view of the two-phase cooling system of FIG. 5A in a second configuration, according to various embodiments.

FIG. 6A is a top view of a condenser, according to various embodiments.

FIG. 6B is a top view of a condenser, according to various embodiments.

FIG. 6C is a top view of a condenser, according to various embodiments.

FIG. 7A is a three-dimensional perspective view of a two-phase cooling system having condenser components formed in a stacked geometry, according to various embodiments.

FIG. 7B is a three-dimensional perspective view of a two-phase cooling system having condenser components formed in a stacked geometry, according to various embodiments.

FIG. 8A is a vertical cross-sectional view of a two-phase cooling system, according to various embodiments.

FIG. 8B is a three-dimensional perspective view of the two-phase cooling system of FIG. 8A, according to various embodiments.

FIG. 9 is a flowchart illustrating operations of a method of cooling a heat source, according to various embodiments.

FIG. 10 is a flowchart illustrating operations of a method of cooling a computing device, according to various embodiments.

### DETAILED DESCRIPTION

The following disclosure provides many different embodiments, or examples, for implementing various features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Unless explicitly stated otherwise, each element having the same reference numeral is presumed to have the same material composition and to have a thickness within a same thickness range.

Disclosed embodiments provide cooling systems for computer system components having advantages over existing cooling systems. In this regard, two-phase cooling systems are provided that include a liquid coolant (i.e., a first phase) that absorbs heat from the computer system components and thereby generates a vapor (i.e., a second phase) that is cooled by a condenser to remove the heat. A positioning device is provided that allows a position or orientation of the condenser to be adjusted to increase a spatial overlap of the vapor with the condenser, to thereby increase an efficiency of the heat-transfer coupling between the vapor and the condenser.

Liquid cooling is increasingly being adopted in computer servers, particularly in data centers and high-performance computing (HPC) environments. While air cooling has traditionally been the dominant method for cooling servers due to its simplicity and lower initial costs, liquid cooling offers several advantages that make it appealing for certain server deployments. In data centers, where energy efficiency and cooling capacity are important concerns, liquid cooling may offer significant benefits. Liquid cooling systems may more effectively remove heat from server components, enabling higher-density deployments without risking overheating. This allows data center operators to maximize their server density within the same footprint, reducing the overall space requirements and potentially lowering operational costs.

Liquid cooling also enables more efficient cooling of high-power components, such as CPUs, GPUs, and memory modules, which are increasingly common in modern server architectures. By keeping these components at optimal operating temperatures, liquid cooling may improve performance and reliability, leading to better overall server efficiency. Moreover, liquid cooling may contribute to energy savings in data centers by reducing the need for mechanical cooling systems, such as air conditioning units. By leveraging liquid cooling solutions that utilize ambient or recycled water, data centers may achieve significant reductions in power consumption and cooling costs. As the demand for higher computing densities, energy efficiency, and performance continues to rise, liquid cooling is likely to become increasingly prevalent in server deployments, especially in specialized HPC and hyperscale data center environments.

Liquid cooling technology includes phase-change cooling and two-phase cooling systems. Phase-change cooling and two-phase cooling share the fundamental principle of utilizing phase transitions to achieve cooling, but they differ in their implementation and operation. Phase-change cooling systems employ a refrigerant that undergoes a phase change from liquid to gas and back again to efficiently transfer heat away from heat generating components. This process involves a closed-loop system that includes a compressor, condenser, expansion valve, and evaporator. The compressor compresses the refrigerant into a high-pressure liquid, which then passes through the condenser to release heat and to condense the refrigerant into a liquid. After passing through an expansion valve, the refrigerant evaporates into a low-pressure gas, absorbing heat from the component that is being cooled. This gas is then cycled back to the compressor to repeat the process.

In contrast, two-phase cooling encompasses a broader category of cooling techniques where both liquid and vapor phases of the coolant coexist simultaneously. In these systems, the coolant partially vaporizes as it absorbs heat from the component, and the resulting mixture of liquid and vapor interacts with a heat exchanger (i.e., a condenser) where the vapor condenses back into liquid, releasing the absorbed heat. This condensed liquid then returns to the component to continue the cooling cycle. Thus, while phase-change cooling is a specific type of cooling system involving phase changes between liquid and gas states, two-phase cooling encompasses a wider range of techniques utilizing both liquid and vapor phases of the coolant concurrently.

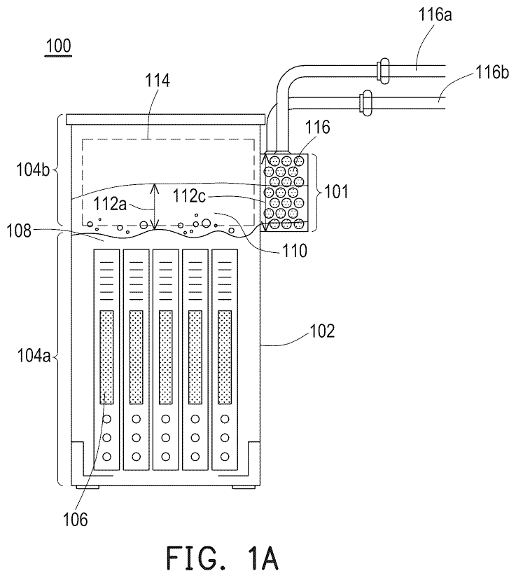

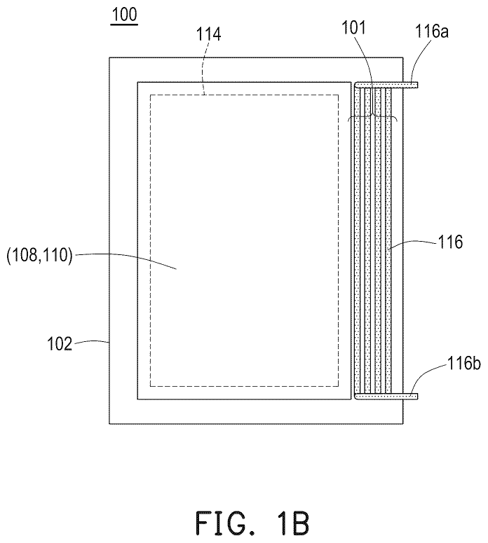

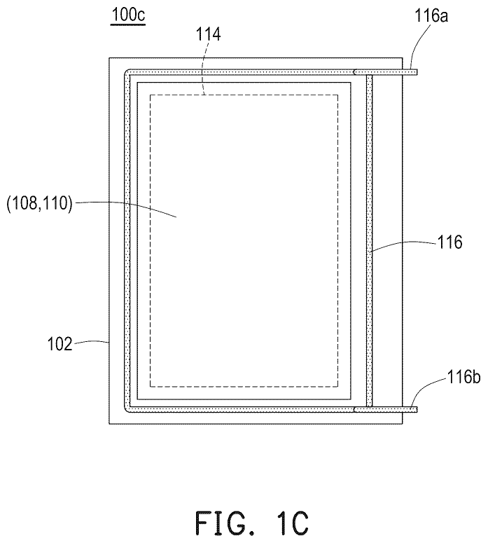

FIG. 1A is a vertical cross-sectional view of a two-phase cooling system 100, according to an embodiment. FIG. 1B is a top view of the two-phase cooling system 100 of FIG. 1A illustrating one configuration of a condenser 101, and FIG. 1C is a top view of the two-phase cooling system of FIG. 1A illustrating a configuration of a condenser 101, according to another embodiment. As shown in FIG. 1A, the two-phase cooling system 100 includes an enclosure 102 having a first volume 104a and a second volume 104b. The two-phase cooling system 100 includes a heat source 106 located in the first volume 104a and a liquid coolant 108 located in the first volume 104a such that the liquid coolant 108 is in contact with the heat source 106. As described above, the two-phase cooling system 100 may be part of a computing system, computer server, data center, etc. As such, in some embodiments, a computing device, which generates heat, functions as the heat source 106.

As the system is operated, heat generated by the heat source 106 is absorbed by the liquid coolant 108, which generates a vapor 110. As shown in FIG. 1A, the vapor 110 partially fills the second volume 104b. If the system were in thermodynamic equilibrium one might expect that the vapor 110 would uniformly fill the second volume 104b. However, during operation, the two-phase cooling system 100 is not in thermodynamic equilibrium, but rather, is in a non-equilibrium steady state in which the vapor 110 is continually generated by heat absorbed by the liquid coolant 108 from the heat source 106. In turn, the vapor 110 generated by the liquid coolant 108 is continually being condensed back into condensed liquid coolant by the condenser 101, which returns to the first volume 104a. In this way, heat is transferred from the heat source 106, to the liquid coolant 108, to the vapor 110, to the condenser 101, and finally out of the system.

Due to the non-equilibrium operation of the two-phase cooling system 100, the vapor 110 does not uniformly fill the second volume 104b. Rather, the vapor 110 has a density distribution characterized by a first height 112a. For example, the vapor 110 has a density distribution that decreases with the distance above a surface of the liquid coolant 108 with a characteristic length scale corresponding to the first height 112a. In this regard, in some embodiments, the vapor density distribution has an exponentially decreasing density as a function of distance above the surface of the liquid coolant 108, with the first height 112a identified as a characteristic length scale of the exponential density dependence. In general, the second volume 104b includes a mixture of vapor 110 and air. The vapor 110 will tend to reside in the bottom portion of the second volume 104b because it has a greater density (e.g., 0.012 g/ml in some embodiments) than that of air (i.e., 0.0013 g/ml).

As shown in FIGS. 1A and 1B, the condenser 101 is located adjacent to a central region 114 of the second volume 104b such that the vapor 110 comes in contact with the condenser 101. The condenser includes a conduit 116 through which a condenser coolant (not shown) flows, such that the condenser coolant absorbs heat from a portion of the vapor 110 that comes in contact with the conduit 116. As shown in FIG. 1A, the conduit 116 includes an inlet conduit 116a and an outlet conduit 116b that allows condenser coolant to flow into and out from the condenser 101. Various materials may be used for the condenser coolant, such as water, a refrigerant, etc.

The degree to which the vapor 110 interacts with the condenser 101 depends on the first height 112a of the vapor. As described above, the first height 112a depends on the non-equilibrium state of the vapor 110. As such, the first height 112a is a function of a rate at which heat is generated by the heat source 106 and a rate at which heat is removed from the vapor 110 by the condenser 101. The heat generation and removal rates further depend on the temperature difference between the heat source 106 and the condenser 101 as well as on the cooling efficiency between the condenser 101 and the vapor 110. As shown in FIG. 1A, the vapor 110 does not fully overlap with the condenser 101 due to the fact that the vapor 110 does not fully fill the second volume 104b.

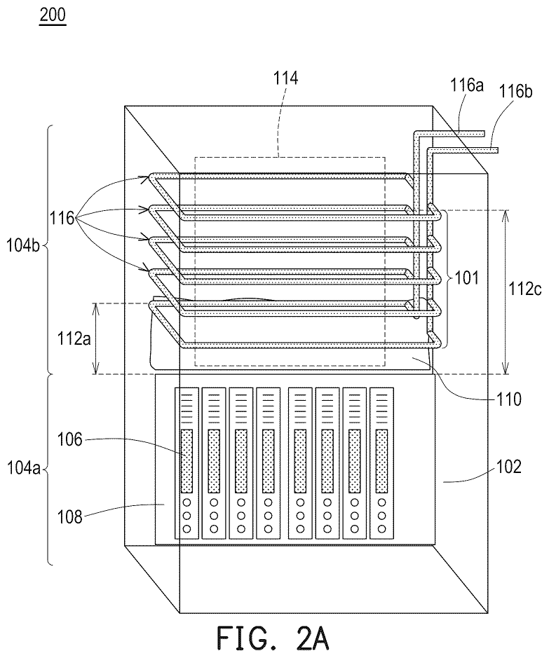

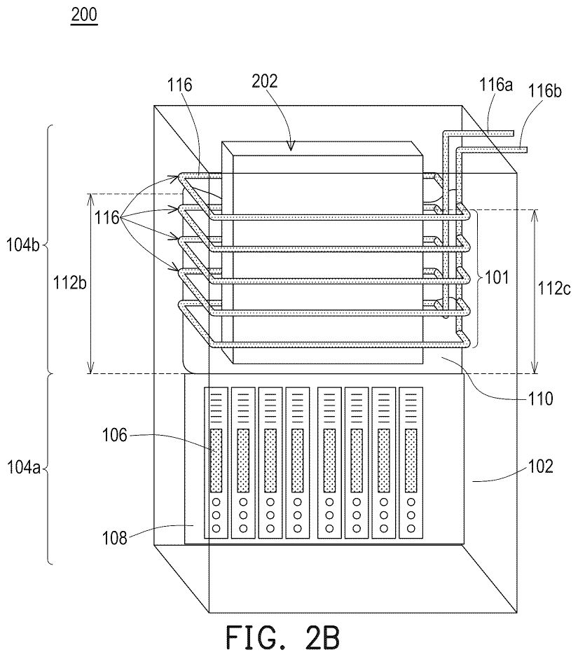

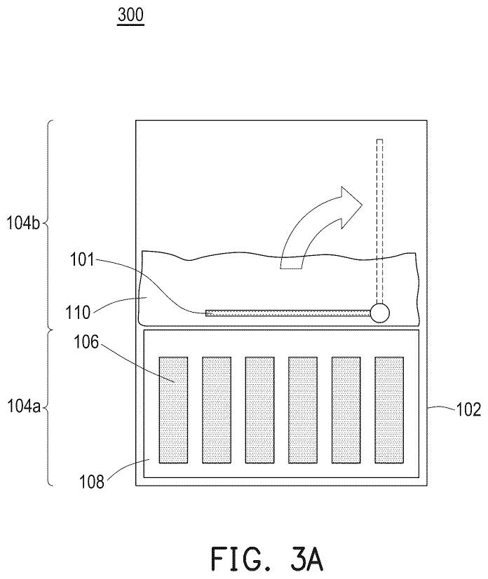

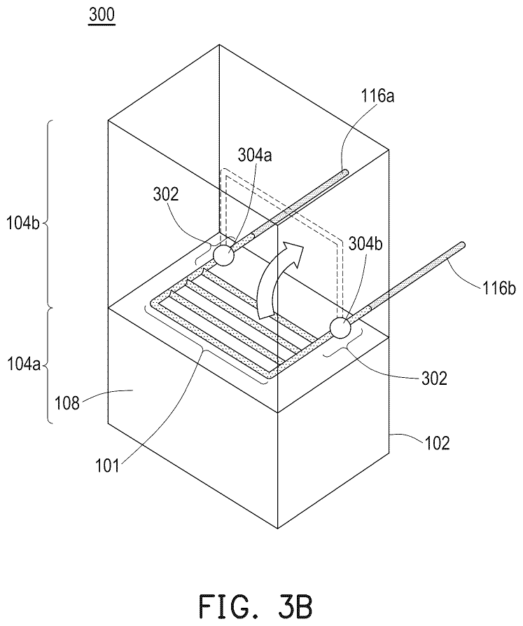

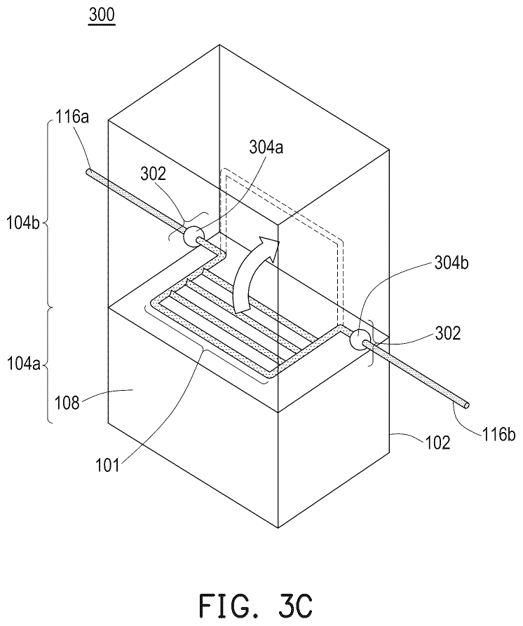

According to some embodiments, described below with reference to FIGS. 3A to 7B, a position of the condenser 101 is controlled by a positioning device (302, 401, 501), which is attached to attached to the condenser 101, and that controls a position or orientation of the condenser 101 within the second volume 104b. As such, a position or orientation of the condenser 101 is adjusted to optimize a spatial overlap between the condenser 101 and the vapor 110. In this regard, a cooling efficiency between the vapor 110 and the condenser 101 is increased. Alternatively, as described with reference to FIG. 2B, a vapor control device (i.e., a space-filing device 202) is used to increase a height of the vapor 110 to a second height 112b, which is greater than the first height 112a, thus increasing the cooling efficiency between the vapor 110 and the condenser 101.

In some embodiments, the condenser conduit 116 is formed as a coil (e.g., see FIGS. 1B and 1C) extending vertically to a third height 112c above a surface of the liquid coolant 108 (e.g., see FIGS. 1A, 2A, and 2B). As shown in FIGS. 1B and 1C, the condenser 101 is configured to leave the central region 114 of the second volume 104b free of any components of the condenser 101. Leaving such a central region 114 free may be advantageous by providing a space that may be accessed during installation and maintenance of the computer system components that are housed in the first volume 104a. For example, as shown in FIG. 1B, the condenser 101 is located in a space that is adjacent to the central region 114.

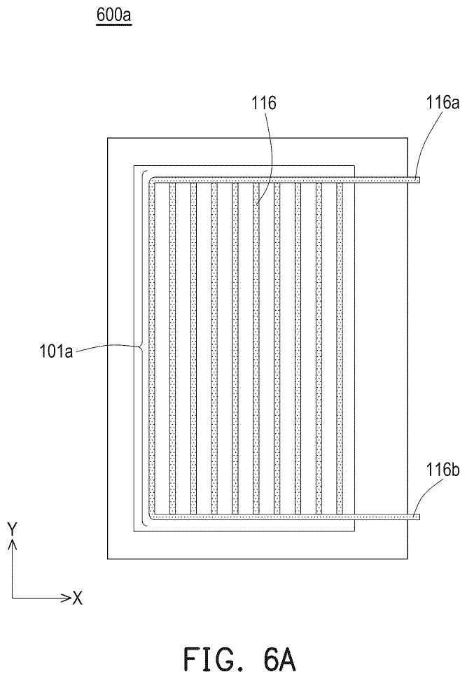

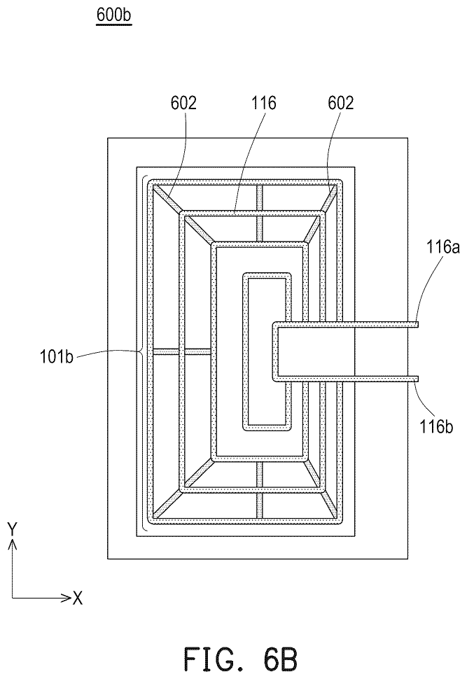

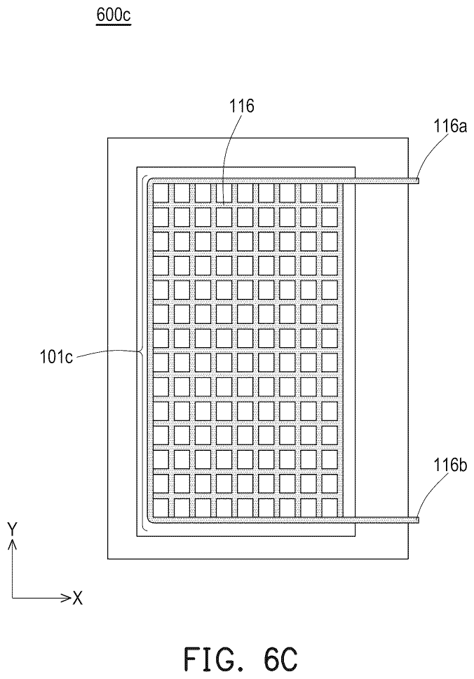

Alternatively, as shown in FIG. 1C, the condenser 101 is formed as a coil around a perimeter of the central region 114. Although the central region 114 provides a convenient access volume for maintenance operations, its presence represents a disadvantage in terms of cooling efficiency between the condenser 101 and the vapor 110. In this regard, the central region 114 represents a volume in which there is no spatial overlap between the vapor 110 and the condenser 101, and as such, there is no coupling between the condenser 101 and the vapor 110 in the central region 114. However, the central region 114 provides a space to accommodate a vapor control device taking the form of a space-filling device 202, which is used to displace the vapor 110 toward the condenser 101, as described in greater detail below (e.g., see FIGS. 2A and 2B). Alternatively, as described with reference to FIGS. 6A to 6C, below, the condenser may be configured to have a geometry that spans the central region 114 but may be further configured to be movable so that, during maintenance operations, the condenser 116 may be repositioned or removed, as needed, to leave a space within the central region 114, as described with reference to FIGS. 3A to 7B, below.

FIG. 2A is a schematic view of a two-phase cooling system 200 in a first configuration, where a second volume 104b is shown in a three-dimensional perspective view, and FIG. 2B is schematic view of the two-phase cooling system 200 of FIG. 2A in a second configuration, according to various embodiments. As shown in FIGS. 2A and 2B, the two-phase cooling system 200 includes an enclosure 102 having a first volume 104a and a second volume 104b, a heat source 106 located in the first volume 104a, and a liquid coolant 108 located in the first volume 104a such that the liquid coolant 108 is in contact with the heat source 106. A vapor 110 that partially fills the second volume 104b is generated by the liquid coolant 108 when heat generated by the heat source 106 is absorbed by the liquid coolant 108. As shown in FIGS. 2A and 2B, a condenser 101 is located in the second volume 104b and is configured to remove heat from the vapor 110. By removing heat from the vapor 110, the condenser 101 causes the vapor 110 to condense into condensed liquid coolant that returns to the first volume 104a.

In contrast to the two-phase cooling system 100 of FIGS. 1A to 1C, the two-phase cooling system 200 further includes a space-filling device 202 located in the second volume 104b, as shown in FIG. 2B. The space-filling device 202 partially fills the second volume 104b and thereby displaces the vapor 110 from a portion of the second volume 104b. The displaced vapor 110 fills areas surrounding the space-filling device 202 and, as such, a height of the vapor 110 is increased from the first height 112a, which characterizes the vapor 110 when the space-filling device 202 is removed from the second volume 104b, to the second height 112b, which characterizes the vapor 110 when the space-filling device 202 is placed within the second volume 104b. Alternatively, the space-filling device 202 may be removed from the two-phase cooling system 200, thereby leaving the central region 114 free, during installation and maintenance operations. Various space-filling devices 202 may be used in corresponding embodiments.

As shown in FIGS. 1A, 2A, and 2B, the condenser 101 spatially extends in a vertical direction characterized by a third height 112c. In this regard, the conduit 116 is formed as a coil extending vertically to a third height 112c above a surface of the liquid coolant 108. As further shown in FIGS. 1A, 2A, and 2B, the third height 112c is greater than the first height 112a such that when the space-filling device 202 is placed within the second volume 104b the vapor 110 is displaced, thereby increasing a degree to which the vapor 110 comes in contact with the condenser 101. As such, the presence of the space-filling device 202 increases the cooling efficiency between the vapor 110 and the condenser 101. Alternatively, in other embodiments, the condenser 101 has other configurations and has a position or orientation that is adjustable to increase an overlap between the condenser 101 and the vapor 110, as described in greater detail with reference to FIGS. 3A to 7B, below.

The first height 112a of the vapor 110 above a surface of the liquid coolant is a function of the temperature of the liquid coolant 108, the temperature of the condenser 101, and the specific properties of the liquid coolant 108. In certain embodiments, the liquid coolant 108 is a fluorine-based chemical having a boiling point between 46 °C and 55 °C, a latent heat between 90 kJ/kg and 125 kJ/kg, and a vapor pressure between 30 kPa and 40 kPa at temperature of approximately 20 °C. Some example chemicals that may be used as the liquid coolant 108 are listed as follows: HT-55 ((perfluoropolyether) (1-propene, 1,1,2,3,3,3-hexafluoro-, oxidized, polymerized)) available from Galden; Novec 7200 (ethyl nonafluoroisobutyl ether) available from 3M; FC16P (1,1,1,2,2,4,5,5,5-nonafluoro-4-(trifluoromethyl)-3-pentanone) available from Taimax; Novec 649 (1,1,1,2,2,4,5,5,5-nonafluoro-4-(trifluoromethyl)-3-pentanone) available from 3M; FC-3284 (perfluoro compounds, C5-18) available from 3M; FC18P (2-pentene, 1,1,1,2,3,4,5,5,5-nonafluoro-4-(trifluoromethyl)) available from Taimax; IM6 (perfluoro(4-methylpent-2-ene)) available from Inventec; 2100A (perfluoro(4-methylpent-2-ene)) available from Noah; DAISAVE SS-54 (1,1,2,3,3,3-hexafluoropropyl methyl ether) available from Daikin; and Opteon 2P50 (hydrofluoroolefin) available from Chemours.

FIG. 3A is a vertical cross-sectional view of a two-phase cooling system 300, according to various embodiments. FIG. 3B is a three-dimensional perspective view of the two-phase cooling system 300 of FIG. 3A in a first configuration and FIG. 3B is a three-dimensional perspective view of the two-phase cooling system of FIG. 3A in a second configuration, according to various embodiments.

As shown in FIGS. 3A to 3C, the two-phase cooling system 300 includes an enclosure 102 having a first volume 104a and a second volume 104b, a heat source 106 located in the first volume 104a, and a liquid coolant 108 located in the first volume 104a such that the liquid coolant 108 is in contact with the heat source 106. A vapor 110 that partially fills the second volume 104b is generated by the liquid coolant 108 when heat generated by the heat source 106 is absorbed by the liquid coolant 108. As shown in FIGS. 3A to 3C, a condenser 101 is located in the second volume 104b and is configured to remove heat from the vapor 110. By removing heat from the vapor 110, the condenser 101 causes the vapor 110 to condense into condensed liquid coolant that returns to the first volume 104a. In contrast to the two-phase cooling system 100 of FIGS. 1A to 1C, and the two-phase cooling system 200 of FIGS. 2A and 2B, the two-phase cooling system 300 of FIGS. 3A to 3C further includes a positioning device 302, located in the second volume 104b, which is attached to the condenser 101 and that controls a position or orientation of the condenser 101 within the second volume 104b. As shown in FIGS. 3B and 3C, the condenser 101 is configured to have a planar geometry that spans an area of the central region 114 of the second volume 104b.

According to various embodiments, the positioning device 302 is provided with a hinge (304a, 304b) that is configured to allow the condenser 101 to be positioned in a first angular configuration (e.g., positioned horizontally) and a second angular configuration (e.g., positioned vertically; see dashed lines in FIGS. 3B and 3C). In further embodiments, the positioning device 302 is configured to allow the condenser 101 to be positioned at any angle within a predetermined range of angles (e.g., between 0 and 90 degrees relative to the horizontal direction, etc.). In various embodiments, the positioning device 302 also provides a fluid connection to the condenser 101.

For example, according to various embodiments, the hinge (304a, 304b) includes a first portion 304a, which provides a fluid connection between the condenser 101 and an inlet conduit 116a, and a second portion 304b, which provides a fluid connection between the condenser 101 and an outlet conduit 116b. As shown in FIGS. 3B and 3C, the inlet conduit 116a and the outlet conduit 116b are provided in various configurations. For example, in FIG. 3B the inlet conduit 116a and the outlet conduit 116b are provided in a linear configuration such that each of the inlet conduit 116a and the outlet conduit 116b share a common axis with respective components of the condenser 101. Alternatively, the inlet conduit 116a and the outlet conduit 116b may be configured at right angles (or at various other angles) relative to corresponding components of the condenser 101.

According to various embodiments, at least one of the first portion 304a or the second portion 304b may be provided as a linear hinge, a two-dimensional hinge, or a three-dimensional ball hinge. For example, as shown in FIGS. 3B and 3C, the hinge (304a, 304b) is configured to allow rotational motion around a symmetry axis (e.g., an axis coinciding with the inlet conduit 116a and the outlet conduit 116b). In other embodiments, the positioning device 302 need not provide a fluid connection. For example, in some embodiments (not shown) a three-dimensional ball hinge is attached to the condenser 101 such that the condenser 101 has three-dimensional positional freedom relative to a contact point of the three-dimensional ball hinge. In such embodiments, the inlet conduit 116a and the outlet conduit 116b is connected to flexible tubing (not shown) that allows condenser fluid to be provided to the condenser 101 without further constraining a three-dimensional positioning of the condenser 101.

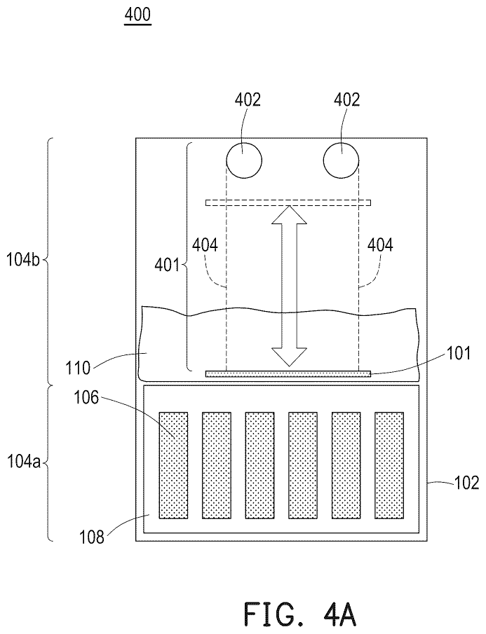

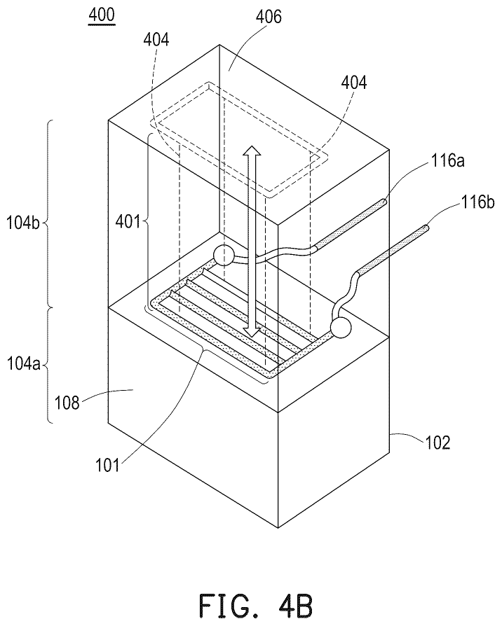

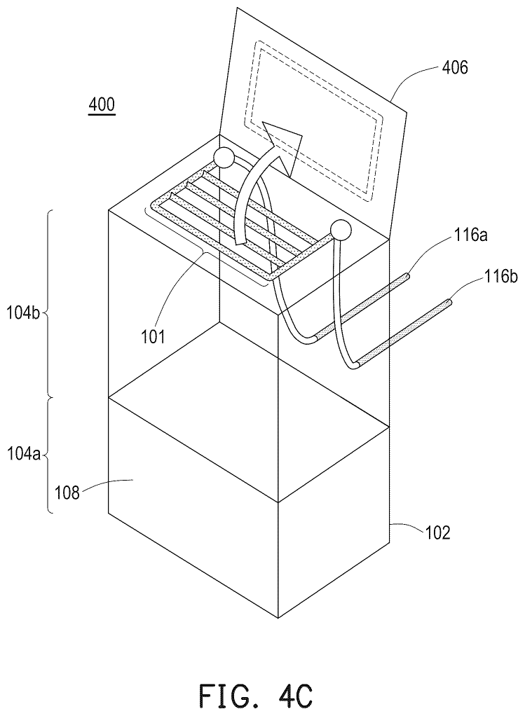

FIG. 4A is a vertical cross-sectional view of a two-phase cooling system 400, according to various embodiments. FIG. 4B is a three-dimensional perspective view of the two-phase cooling system 400 of FIG. 4A in a first configuration and FIG. 4B is a three-dimensional perspective view of the two-phase cooling system 400 of FIG. 4A in a second configuration, according to various embodiments.

The two-phase cooling system 400 of FIGS. 4A to 4C includes many components that are similar to respective components of the two-phase cooling system 300 of FIGS. 3A to 3C. In this regard, the two-phase cooling system 400 includes an enclosure 102 having a first volume 104a and a second volume 104b, a heat source 106 located in the first volume 104a, and a liquid coolant 108 located in the first volume 104a such that the liquid coolant 108 is in contact with the heat source 106. A vapor 110 that partially fills the second volume 104b is generated by the liquid coolant 108 when heat generated by the heat source 106 is absorbed by the liquid coolant 108. As shown in FIGS. 4A to 4C, a condenser 101 is located in the second volume 104b and is configured to remove heat from the vapor 110. By removing heat from the vapor 110, the condenser 101 causes the vapor 110 to condense into condensed liquid coolant that returns to the first volume 104a. As shown in FIGS. 4B and 4C, the condenser 101 is configured to have a planar geometry that spans an area of the central region 114 of the second volume 104b.

In contrast to the two-phase cooling system 300 of FIGS. 3A to 3C, the two-phase cooling system 400 of FIGS. 4A to 4C includes a positioning device 401 that is configured to move the condenser 101 along a single direction within the second volume. For example, as shown in FIGS. 4A to 4C, the positioning device 401 is configured to move the condenser 101 along a direction (e.g., the vertical direction in FIGS. 4A to 4C) perpendicular to a plane of the condenser 101 within the second volume 104b. As shown in FIGS. 4B and 4C, the condenser 101 is connected to a flexible inlet conduit 116a and a flexible outlet conduit 116b. The presence of the flexible inlet conduit 116a and a flexible outlet conduit 116b allows relatively free motion of the condenser 101 within the second volume 104b. As such, a position of the condenser 101 is adjusted to optimize overlap between the condenser 101 and the vapor 110 and to thereby increase a cooling efficiency of the condenser 101.

According to various embodiments, the positioning device 401 is provided as a pulley 402 and a cable 404 that is attached to the pulley 402 on a first end (e.g., a top end) of the cable and attached to the condenser 101 on a second end (e.g., a bottom end) of the cable 404, as shown in FIGS. 4A and 4B. As such, a height of the condenser 101 along a vertical direction within the second volume 104b is adjustable based on a configuration of the pulley 402, which is adjustable and configured to allow the cable 404 to be shortened or lengthened. Further, as shown in FIG. 4C, for example, the condenser 101 may be raised to a top of the second volume 104b and may be removed from the second volume (see arrow in FIG. 4C) during maintenance, installation, etc.

The pulley 402 may be attached to a top portion of the second volume 104b (not shown) or may be attached to a lid 406 of the two-phase cooling system 400. Further, a configuration of the pulley 402 (i.e., a rotational angle) may be controlled manually or by an actuator (e.g., a motor). The actuator (not shown), in some embodiments, is remote controlled, for example, by a wireless connection between an (internal or external) computing device and the actuator. In various embodiments, the actuator is controlled using a control circuit. For example, a control circuit may be coupled to a sensor that determines a density of the vapor 110. The control circuit may be configured to adjust a height of the condenser 101 depending on a measured density of the vapor 110 to thereby optimize the cooling efficiency of the condenser 101.

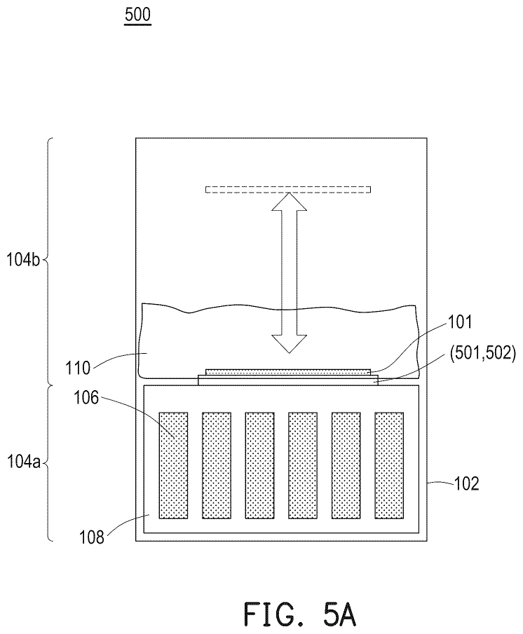

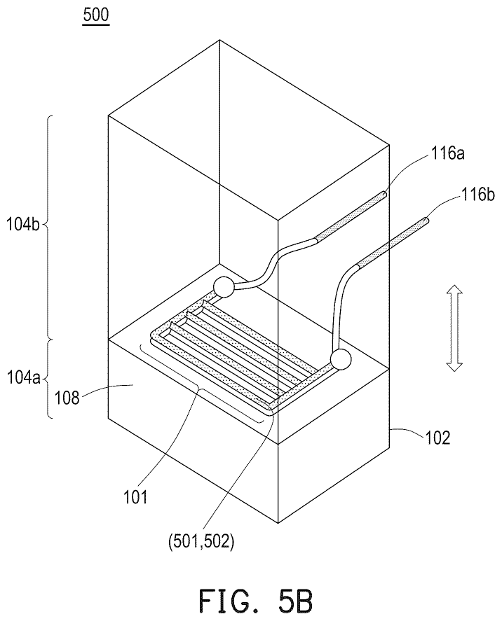

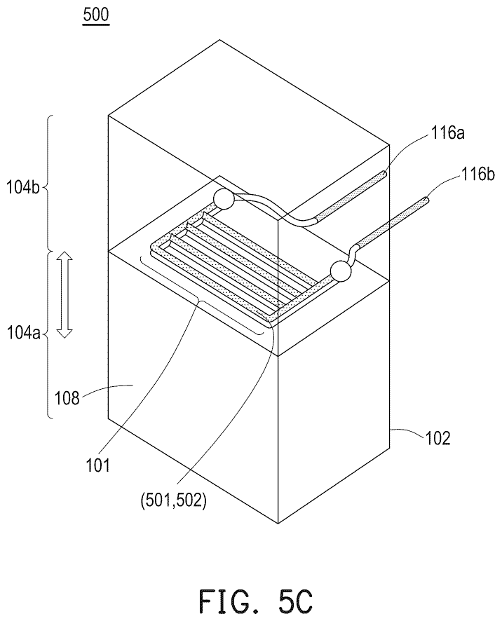

FIG. 5A is a vertical cross-sectional view of a two-phase cooling system 500, according to various embodiments. FIG. 5B is a three-dimensional perspective view of the two-phase cooling system 500 of FIG. 5A in a first configuration and FIG. 5B is a three-dimensional perspective view of the two-phase cooling system 500 of FIG. 5A in a second configuration, according to various embodiments. The two-phase cooling system 500 of FIGS. 5A to 5C includes many components that are similar to respective components of the two-phase cooling system 300 of FIGS. 3A to 3C and of the two-phase cooling system 400 of FIGS. 4A to 4C. In contrast to these other embodiment two-phase cooling systems (300, 400), however, a positioning device 501 of the two-phase cooling system 500 includes a buoyant object 502 that is configured to float on a surface of liquid coolant 108 and to support the condenser 101. As such, the positioning device (501, 502) allows a height of the condenser 101 to vary as a height of a surface of the liquid coolant 108 varies.

As shown in FIGS. 5B and 5C, the condenser 101 is connected to a flexible inlet conduit 116a and a flexible outlet conduit 116b. The presence of the flexible inlet conduit 116a and a flexible outlet conduit 116b allows relatively free motion of the condenser 101 within the second volume 104b in response to changes in height of the liquid coolant 108.

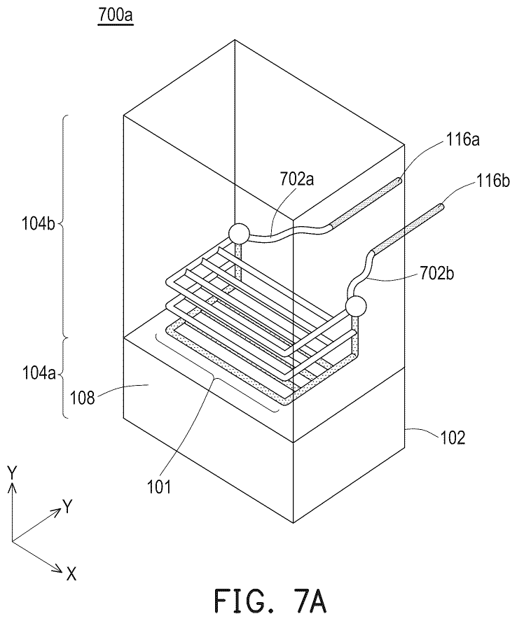

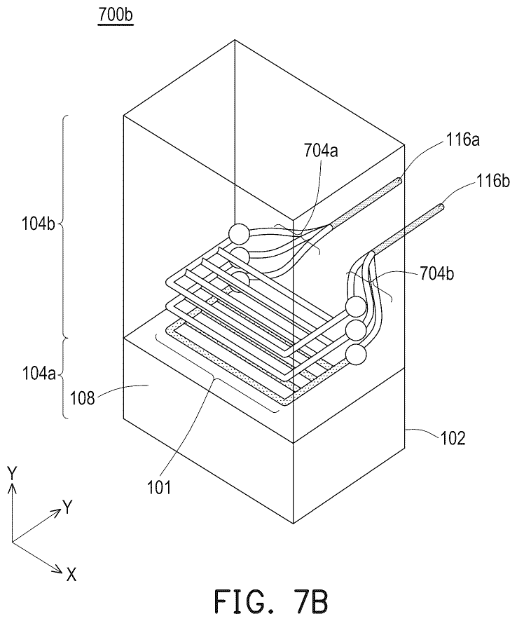

FIGS. 6A, 6B, and 6C provide top views of respective condensers (101a, 101b, 101c) provided in respective two-phase cooling systems (600a, 600b, 600c), according to various embodiments. Each of the condensers (101a, 101b, 101c) includes an inlet conduit 116a and an outlet conduit 116b such that condenser coolant may be provided to each respective condenser (101a, 101b, 101c). A fluid pathway through the condenser (101a, 101b, 101c), however, depends on the particular design of the condenser (101a, 101b, 101c). For example, in the condenser 101a, fluid pathways are provided in the form of a grid of conduits 116 that are arranged parallel with a single axis (i.e., the y-axis), while in the condenser 101c, the fluid pathways are provided in the form of a grid of conduits 116 that are arranged parallel with a first axis (i.e., the x-axis) and with a second axis (i.e., the y-axis). In still further embodiments, as shown in FIG. 6B, the fluid pathways are configured to allow the condenser coolant to flow in a loop path from the inlet conduit 116a to the outlet conduit 116b. As shown in FIG. 6B, the condenser 101 includes various support structures 602 that mechanically support the conduits 116 in the condenser 101. The condenser 101 may have various other configurations, as described in greater detail with reference to FIGS. 7A and 7B, below.

FIGS. 7A and 7B are three-dimensional perspective views of respective two-phase cooling systems (700a, 700b), according to various embodiments. As shown, in each of the respective two-phase cooling systems (700a, 700b), the condenser 101 is configured as a plurality of planar segments configured in a stacked geometry along a direction perpendicular to the plane of the condenser. In this regard, as shown in FIGS. 7A and 7B, each of the planar segments are aligned parallel to the X-Y plane and are stacked in the Z direction (i.e., the direction perpendicular to the plane of each segment).

Each of the condensers 101 in the respective two-phase cooling systems (700a, 700b) includes an inlet conduit 116a and an outlet conduit 116b such that condenser coolant may be provided to each respective condenser 101. As shown in FIGS. 7A and 7B, however, there are various ways to connect the inlet conduit 116 a and the outlet conduit 116b to the condenser 101. For example, in the two-phase cooling system 700a of FIG. 7A, the inlet conduit 116a and an outlet conduit 116b include respective single flexible segments (702a, 702b), whereas, in the in the two-phase cooling system 700b of FIG. 7B, the inlet conduit 116a and an outlet conduit 116b include respective flexible multiple segments (704a, 704b).

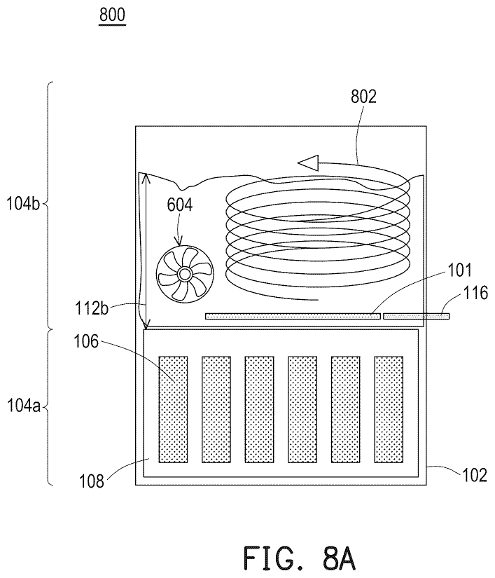

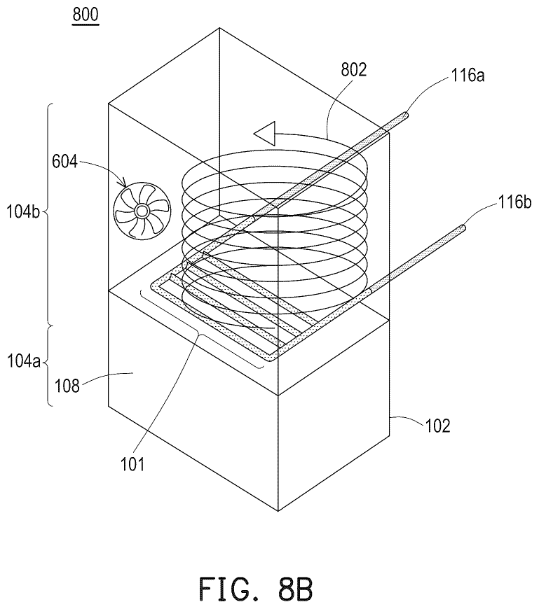

FIG. 8A is a vertical cross-sectional view of a two-phase cooling system 800, and FIG. 8B is a three-dimensional perspective view of the two-phase cooling system 800 of FIG. 8A, according to various embodiments. The two-phase cooling system 800 of FIGS. 8A and 8B is similar to the two-phase cooling systems (700a, 700b) of FIGS. 7A and 7B; the two-phase cooling system 400 of FIGS. 4A to 4C; the two-phase cooling system 300 of FIGS. 3A to 3C; and the two-phase cooling system 200 of FIGS. 2A and 2B. In contrast to these previously-described systems, however, the two-phase cooling system 800 employs a different kind of vapor control device to control a density distribution of the vapor 110.

In this regard, a fan 604 is positioned within the second volume 104b of the enclosure or may be positioned externally to the second volume 104b and may be connected to the second volume 104b by a gas conduit (not shown). The fan 604 causes circulation 802 of the vapor 110 and other gases (e.g., air) within the second volume 104b. The circulation 802 of the vapor 110 within the second volume 104b allows a greater amount of the vapor 110 to come into contact with the condenser 101 than would otherwise come into contact with the condenser 101 in the absence of the circulation 802. As such, the fan 604 functions as a vapor control device that increases a cooling efficiency between the vapor 110 and the condenser 101.

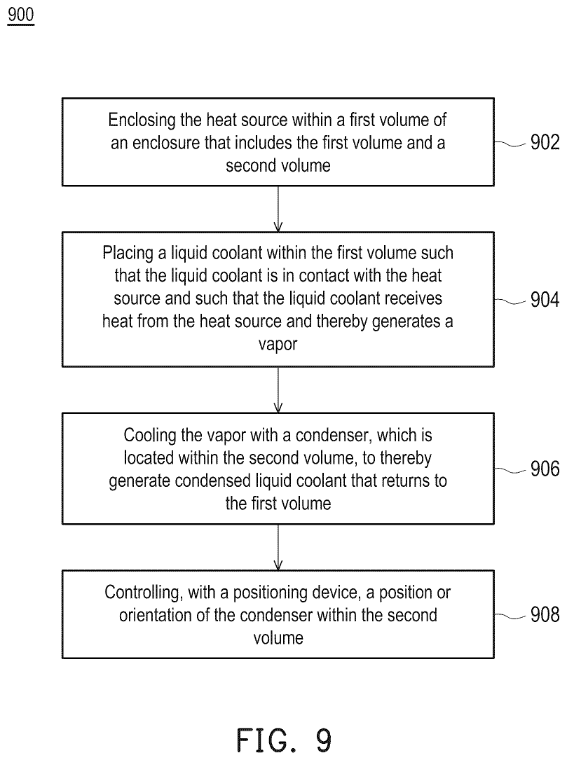

FIG. 9 is a flowchart illustrating operations of a method 900 of cooling a heat source 106, according to various embodiments. In operation 902, the method 900 includes enclosing the heat source 106 within a first volume 104a of an enclosure 102 that includes the first volume 104a and a second volume 104b. In operation 904, the method 900 includes placing a liquid coolant 108 within the first volume 104a such that the liquid coolant 108 is in contact with the heat source 106 and such that the liquid coolant 108 receives heat from the heat source 106 and thereby generates a vapor 110. In operation 906, the method 900 includes cooling the vapor 110 with a condenser 101, which is located within the second volume 104b, to thereby generate condensed liquid coolant 108 that returns to the first volume 104a. In operation 908, the method 900 includes controlling, with a positioning device (302 401, 501), a position or orientation of the condenser 101 within the second volume 104b.

According to various embodiments, the positioning device 302 includes a hinge (304a, 304b), and the method 900 further includes controlling an angular configuration of the condenser 101 by positioning the hinge (304a, 304b) in one of a first angular configuration (e.g., horizontal) or a second angular configuration (e.g., vertical). According to various embodiments, the method 900 further includes configuring the hinge (304a, 304b) to include a first portion 304a, which provides a fluidic connection between the condenser 101 and an inlet conduit 116a, and a second portion 304b, which provides a fluidic connection between the condenser 101 and an outlet conduit 116b. According to various embodiments, the condenser 101 has a planar geometry, and the method 900 further includes controlling the positioning device 401 to adjust a position of the condenser 101 along a direction (e.g., the z-axis) perpendicular to a plane (e.g., the x-y plane) of the condenser 101 within the second volume 104b.

According to various embodiments, the method 900 further includes configuring the condenser 101 to be connected to a flexible inlet conduit 116a and a flexible outlet conduit 116b such that the condenser 101 is configured to allow condenser coolant to flow through the condenser 101 in various positions or orientations of the condenser 101 as determined by the positioning device (302, 401, 501).

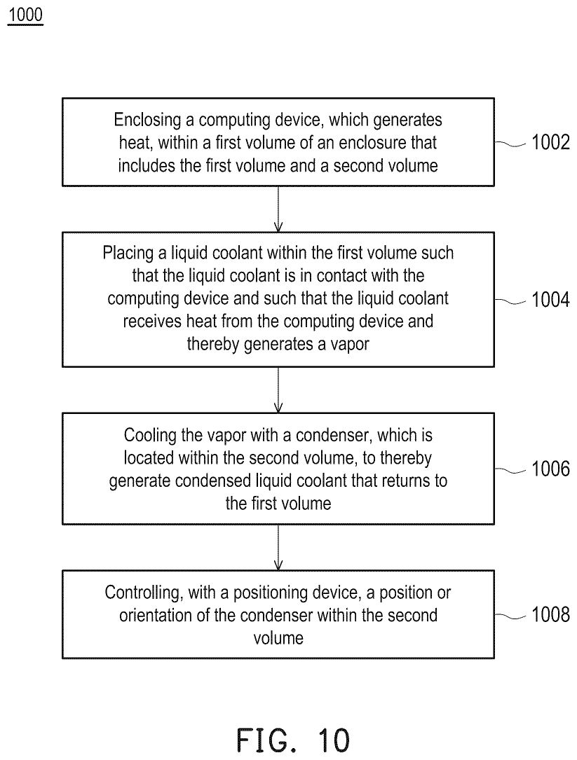

FIG. 10 is a flowchart illustrating operations of a method 1000 of cooling a computing device 106, according to various embodiments. In operation 1002, the method 1000 includes enclosing a computing device (i.e., an example heat source 106), which generates heat, within a first volume 104a of an enclosure 102 that includes the first volume 104a and a second volume 104b. In operation 1004, the method 1000 includes placing a liquid coolant 108 within the first volume 104a such that the liquid coolant 108 is in contact with the computing device 106 and such that the liquid coolant 108 receives heat from the computing device 106 and thereby generates a vapor 110. In operation 1006, the method 1000 includes cooling the vapor 110 with a condenser 101, which is located within the second volume 104b, to thereby generate condensed liquid coolant 108 that returns to the first volume 104a. In operation 1008, the method 1000 includes controlling, with a positioning device (302, 401, 501), a position or orientation of the condenser 101 within the second volume 104b.

According to various embodiments, the method 1000 further includes configuring the condenser 101 to be connected to a flexible inlet conduit 116a and a flexible outlet conduit 116b such that the condenser 101 is configured to allow condenser coolant to flow through the condenser 101 in various positions or orientations of the condenser 101 as determined by the positioning device (302, 401, 501). According to various embodiments, the method 1000 further includes configuring the condenser 101 to have a planar geometry and controlling the positioning device 401 to adjust a position of the condenser 101 along a direction perpendicular to a plane of the condenser 101 within the second volume 104b. According to various embodiments, the method 1000 further includes configuring the condenser 101 to include two or more planar segments configured in a stacked geometry along the direction perpendicular to plane of the condenser 101.

Referring to all drawings and according to various embodiments of the present disclosure, a two-phase cooling system (300, 400, 500, 700a, 700b) is provided. The two-phase cooling system (300, 400, 500, 700a, 700b) includes an enclosure 102 having a first volume 104a and a second volume 104b and a heat source 106 located in the first volume 104a. According to various embodiments, the first volume 104a is configured to contain a liquid coolant 108 such that the liquid coolant 108 is in contact with the heat source 106, and the second volume 104b is configured to contain a vapor 110 partially filling the second volume 104b that is generated by the liquid coolant 108 when heat generated by the heat source 106 is absorbed by the liquid coolant 108. According to various embodiments, a condenser 101 is located in the second volume 104b and is configured to remove heat from the vapor 110 so that the vapor 110 condenses into a liquid that returns to the first volume 104a. According to various embodiments, the two-phase cooling system (300, 400, 500, 700a, 700b) further includes a positioning device (302, 401, 501), located in the second volume 104b, which is attached to the condenser 101 and that controls a position or orientation of the condenser 101 within the second volume 104b.

According to various embodiments, the positioning device 302 includes a hinge (304a, 304b) configured to allow the condenser 101 to be positioned in a first angular configuration and a second angular configuration. According to various embodiments, the hinge (304a, 304b) includes a first portion 304a, which provides a fluid connection between the condenser 101 and an inlet conduit 116a, and a second portion 304b, which provides a fluid connection between the condenser 101 and an outlet conduit 116b. According to various embodiments, at least one of the first portion 304a or the second portion 304b includes a linear hinge, a two-dimensional hinge, or a three-dimensional ball hinge. According to further embodiments, the positioning device 401 is configured to move the condenser 101 along a single direction within the second volume 104b. And in still further embodiments, the condenser 101 is connected to a flexible inlet conduit 116a and a flexible outlet conduit 116b.

According to various embodiments, the condenser 101 has a planar geometry and the positioning device 401 is configured to move the condenser 101 along a direction perpendicular to a plane of the condenser 101 within the second volume 104b. In this regard, in some embodiments, the positioning device 401 includes a pulley 402 and a cable 404 that is attached to the pulley 402 on a first end of the cable 404 and attached to the condenser 101 on a second end of the cable 404. As such, a height of the condenser 101, along a vertical direction within the second volume 104b, is adjustable based a configuration of the pulley 402, which is adjustable and configured to allow the cable 404 to be shortened or lengthened. In still-further embodiments, the pulley 402 is attached to an actuator. According to various embodiments, the actuator is configured to be remotely controlled. According to various embodiments, the positioning device 501 is configured to float on a surface of liquid coolant 108 and to support the condenser 101 thereby allowing a height of the condenser 101 to vary as a height of a surface of the liquid coolant 108 varies.

Disclosed embodiments provide cooling systems for computer system components 106 having advantages over existing cooling systems. In this regard, two-phase cooling systems (300, 400, 500, 700a, 700b) are provided that include a liquid coolant 108 (i.e., a first phase) that absorbs heat from the computer system components 106 and thereby generates a vapor 110 (i.e., a second phase) that is cooled by a condenser 101 to remove the heat. A positioning device (302, 401, 501) is provided that allows a position or orientation of the condenser 101 to be adjusted to increase a spatial overlap of the vapor 110 with the condenser 101, to thereby increase an efficiency of the heat-transfer coupling between the vapor 110 and the condenser 101.

According to various embodiments, a two-phase cooling system includes an enclosure having a first volume and a second volume and a heat source located in the first volume. According to various embodiments, the first volume is configured to contain a liquid coolant such that the liquid coolant is in contact with the heat source, and the second volume is configured to contain a vapor of the liquid coolant. According to various embodiments, a condenser is located in the second volume and is configured to remove heat from the vapor so that the vapor condenses into a liquid. According to various embodiments, the two-phase cooling system further includes a positioning device, located in the second volume, which is attached to the condenser and that controls a position or orientation of the condenser within the second volume.

According to various embodiments, the positioning device includes a hinge configured to allow the condenser to be positioned in a first angular configuration and a second angular configuration. According to various embodiments, the hinge includes a first portion, which provides a fluid connection between the condenser and an inlet conduit, and a second portion, which provides a fluid connection between the condenser and an outlet conduit. According to various embodiments, at least one of the first portion or the second portion includes a linear hinge, a two-dimensional hinge, or a three-dimensional ball hinge. According to further embodiments, the positioning device is configured to move the condenser along a single direction within the second volume. And in still further embodiments, the condenser is connected to a flexible inlet conduit and a flexible outlet conduit.

According to various embodiments, the condenser has a planar geometry, and the positioning device is configured to move the condenser along a direction perpendicular to a plane of the condenser within the second volume. In this regard, in some embodiments, the positioning device includes a pulley and a flexible cable that is attached to the pulley on a first end of the flexible cable and attached to the condenser on a second end of the flexible cable. As such, a height of the of the condenser, along a vertical direction within the second volume, is adjustable based on a configuration of the pulley, which is adjustable and configured to allow the flexible cable to be shortened or lengthened. In still-further embodiments, the pulley is attached to an actuator. According to various embodiments, the actuator is configured to be remotely controlled. According to various embodiments, the positioning device is configured to float on a surface of liquid coolant and to support the condenser thereby allowing a height of the condenser to vary as a height of a surface of the liquid coolant varies.

An embodiment method includes enclosing the heat source within a first volume of an enclosure that includes the first volume and a second volume, wherein the first volume includes a liquid coolant such that the liquid coolant is in contact with the heat source. The method further includes heating the liquid coolant with heat from the heat source, thereby generating a vapor of the liquid coolant. The method further includes cooling the vapor with a condenser, which is located within the second volume, to thereby generate condensed liquid coolant that returns to the first volume. The method further includes controlling, with a positioning device, a position or orientation of the condenser within the second volume.

According to various embodiments, the positioning device includes a hinge, and the method further includes controlling an angular configuration of the condenser by positioning the hinge in one of a first angular configuration (e.g., horizontal) or a second angular configuration (e.g., vertical). In this regard, the hinge includes a first portion, which provides a fluid connection between the condenser and an inlet conduit, and a second portion, which provides a fluid connection between the condenser and an outlet conduit. According to various embodiments, the condenser has a planar geometry, and the method further includes controlling the positioning device to adjust a position of the condenser along a direction (e.g., the z-axis) perpendicular to a plane (e.g., the x-y plane) of the condenser within the second volume.

According to various embodiments, the condenser is connected to a flexible inlet conduit and a flexible outlet conduit, and the condenser is configured to allow condenser coolant to flow through the condenser in various positions or orientations of the condenser as determined by the positioning device.

According to various embodiments, a method of cooling a computing device is provided. The method includes enclosing a computing device (an example heat source), which generates heat, within a first volume of an enclosure that includes the first volume and a second volume, wherein the first volume includes a liquid coolant such that the liquid coolant is in contact with the computing device. The method includes generating a vapor of the liquid coolant with the heat generated by the computing device. The method includes condensing the vapor into condensed liquid coolant with a condenser, located within the second volume. The method further includes returning the condensed liquid. The method includes controlling, with a positioning device, a position or orientation of the condenser within the second volume.

According to various embodiments, the condenser is connected to a flexible inlet conduit and a flexible outlet conduit such that the condenser is configured to allow condenser coolant to flow through the condenser in various positions or orientations of the condenser as determined by the positioning device. According to various embodiments, the condenser has a planar geometry, and the method further includes controlling the positioning device to adjust a position of the condenser along a direction perpendicular to a plane of the condenser within the second volume. According to various embodiments, the condenser includes two or more planar segments configured in a stacked geometry along the direction perpendicular to main surfaces of the planar segments.

The foregoing outlines features of several embodiments so that those skilled in the art may better understand the aspects of this disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of this disclosure, and that they may make various changes, substitutions, and alterations herein without departing from the spirit and scope of the present disclosure.

What is claimed is:

1. A two-phase cooling system, comprising:
an enclosure comprising a first volume and a second volume, wherein the first volume is configured to contain a heat source and is configured to contain a liquid coolant that generates a vapor when heated by the heat source;
a condenser located in the second volume; and
a space-filling device located in the second volume, wherein the space-filling device is configured to displace the vapor to increase a spatial overlap of the vapor with the condenser.

2. The two-phase cooling system of claim 1, wherein the space-filling device partially fills the second volume.

3. The two-phase cooling system of claim 1, wherein the space-filling device is configured to displace the vapor from a portion of the second volume to increase a height of the vapor from a first height to a second height, which is greater than the first height.

4. The two-phase cooling system of claim 3, wherein the condenser comprises a conduit formed as a coil extending to a third height above a surface of the liquid coolant.

5. The two-phase cooling system of claim 1, wherein the space-filling device is removable to leave a central region of the second volume free.

6. A two-phase cooling system, comprising:
an enclosure comprising a first volume and a second volume, wherein the first volume is configured to contain a heat source and is configured to contain a liquid coolant that generates a vapor when heated by the heat source;
a condenser located in the second volume; and
a positioning device attached to the condenser, wherein the positioning device is configured to move the condenser along a single direction within the second volume to increase a spatial overlap of the vapor with the condenser.

7. The two-phase cooling system of claim 6, wherein the positioning device comprises a pulley and a cable attached to the condenser.

8. The two-phase cooling system of claim 7, wherein:
the enclosure further comprises a lid; and
the pulley is attached to the lid.

9. The two-phase cooling system of claim 6, further comprising:
a flexible inlet conduit and a flexible outlet conduit fluidically connected to the condenser.

10. The two-phase cooling system of claim 6, further comprising:
an actuator connected to the positioning device and configured to control a position of the positioning device.

11. The two-phase cooling system of claim 10, further comprising:
a sensor configured to determine a density of the vapor; and
a control circuit coupled to the sensor and the actuator,
wherein the control circuit is configured to control the actuator to adjust a height of the condenser depending on a measured density of the vapor.

12. The two-phase cooling system of claim 6, wherein:
the condenser comprises a planar geometry that spans an area of a central region of the second volume.

13. A method of cooling a heat source, the method comprising:
enclosing the heat source within a first volume of an enclosure that includes a second volume;
placing a liquid coolant within the first volume to generate a vapor;
cooling the vapor with a condenser located within the second volume; and
displacing the vapor within the second volume to increase a spatial overlap between the vapor and the condenser.

14. The method of claim 13, further comprising:
controlling a position of the condenser with a positioning device that comprises a hinge.

15. The method of claim 14, wherein the hinge provides a fluid connection between the condenser and an inlet conduit and an outlet conduit.

16. The method of claim 13, further comprising:
controlling a position of the condenser with a positioning device that is configured to move the condenser along a direction perpendicular to a plane of the condenser.

17. The method of claim 13, wherein displacing the vapor further comprises:
actuating a fan that circulates the vapor.

18. The method of claim 13, wherein displacing the vapor further comprises:
positioning a buoyant object within the enclosure that is configured to float on a surface of the liquid coolant.

19. The method of claim 13, wherein placing the liquid coolant within the first volume further comprises:
introducing a fluorine-based chemical into the first volume.

20. The method of claim 13, wherein placing the liquid coolant within the first volume further comprises:
introducing a liquid comprising a boiling point between 46 °C and 55 °C into the first volume.
